(19) United States
(12) Patent Application Publication
(10) Pub. No.: US 2007/0097468 A1
(43) Pub. Date: May 3, 2007

(54) Image forming device for changing composition of image and changing method thereof

(75) Inventors: Song-baik Jin, Seoul (KR); Jong-un Jeong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/504,626

(22) Filed: Aug. 16, 2006

(30) Foreign Application Priority Data
Oct. 31, 2005 (KR) 2005-103224

(51) Int. Cl. H04N 1/46

(52) U.S. Cl. 358/537; 358/538

(57) ABSTRACT

Disclosed are an image forming device for changing a composition of an image and changing method thereof. The image forming device for changing a composition of an image includes a user interfacing part displaying a predetermined image, a composition changing part generating a new image by changing a composition of the image according to a preset composition and a printing part outputting the generated image. Accordingly, a user can easily output the image of his or her desired composition.

### CROSS-REFERENCE TO RELATED APPLICATIONS

This application claims benefit under 35 U.S.C. § 119(a) of Korean Patent Application No. 2005-103224, filed Oct. 31, 2005, in the Korean Intellectual Property Office, the entire disclosure of which is hereby incorporated by reference.

### BACKGROUND OF THE INVENTION

1. Field of the Invention

The present invention relates to an image forming device for changing a composition of an image and changing method thereof. More particularly, the present invention relates to an image forming device for changing a composition of an image and changing method thereof, which provides an image by changing the composition as a user selects.

2. Description of the Related Art

With digital imaging devices such as a digital camera and camcorder being more widely used, there is an increasing desire by users for more functionality than just storing an image imaged by the digital imaging device in a storing medium such as a hard disc drive of a computer. That is, users additionally desire the ability to output images on paper for long term keeping.

In response to the user's demand, there are newly developed photo printers that output a photo equivalent to a general film photo, on photo paper, as well as a general high-resolution printer.

In outputting the image using a printer, a conventional printer prints the image without changes, thus making it impossible to avoid printing unnecessary parts and wasting developing agents. Accordingly, the user can not obtain the image in a more desired form.

In order to solve this problem, there is a newly launched printer which allows selecting an image area to be printed. The printer provides a function of enlarging and reducing a predetermined selected image area to be printed, and a function of moving the area up and down, and left and right.

The conventional printer which allows selection of an area to be printed inconveniently requires the user to use buttons for moving up and down, and left and right, and buttons for enlargement and reduction. Accordingly, the user is inconvenienced by the necessity of manipulating the buttons and needs excessive time in setting the area to be printed. Also, the user may experience difficulty in judging a composition of an image in the area to be printed.

Accordingly, there is a need for an improved image forming device and method for changing the composition of an image.

### SUMMARY OF THE INVENTION

Exemplary embodiments of the present invention address at least the above problems and/or disadvantages of the related art and to provide at least the advantages described below. Accordingly, an aspect of the present invention is to provide an image forming device for changing a composition of an image and changing method thereof.

In order to achieve the above-described aspects of the present invention, there is provided an image forming device for changing a composition of an image comprising a user interfacing unit for displaying an input image, a composition changing unit for generating a new image by changing a composition of the input image according to a determined composition and a printing unit for outputting the generated image.

The user interfacing unit receives input regarding a reference area to be applied for changing the composition of the displayed image from the user, and the composition changing unit changes the composition of the image according to the determined composition based on the received reference area.

The image forming device may further comprise a controlling unit for controlling a plurality of images generated by the composition changing unit for a plurality of compositions, respectively, to be displayed on the user interfacing unit when the determined composition is two or more.

The composition changing unit changes the composition by moving a center point of the received reference area in an interval.

The user interfacing unit receives an output direction to be applied for outputting the image from the user, and the composition changing unit generates the new image in the received output direction.

The determined composition may be at a golden ratio in consideration of a stable location of a subject in the image.

According to an exemplary embodiment of the present invention, a method for changing a composition of an image by an image forming device, comprises receiving and displaying an input image, generating a new image by changing a composition of the input image according to a determined composition and outputting the generated image.

The method for changing a composition of an image by an image forming device may further comprise receiving input regarding a reference area to be applied for changing the composition of the displayed image, and the new image is obtained by changing the composition of the input image according to at least one composition based on the received reference area, in the operation of generating the new image.

The reference area input may be received through at least one of an operation panel and an externally connected device, in the operation of receiving the reference area.

The method for changing a composition of an image by an image forming device may further comprise displaying a plurality of images generated for the plurality of compositions, respectively when the determined composition is two or more.

The method for changing a composition of an image by an image forming device may further comprise receiving an image to be output by the plurality images from the user, and the received image is output in the operation of outputting the image.

The composition may be changed by moving a center point of the received reference area in an interval in the operation of generating the new image.

The method for changing a composition of an image of an image forming device of may further comprise receiving an output direction to be applied for outputting the image, and the image may be generated in the received output direction in the operation of generating the new image.

At least one composition may be at a golden ratio in consideration of a stable location of a subject in the image.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a block diagram of an image forming device for changing a composition of an image according to an exemplary embodiment of the present invention;

FIG. 2 is an example of changing a composition by use of the image forming device according to an exemplary embodiment of the present invention;

FIG. 3 is provided to explain an exemplary method for changing a composition of a composition changing unit of FIG. I;

FIG. 4 exemplifies a result of changing the composition by the composition changing unit of FIG. 1; and

FIG. 5 is a flowchart explaining a method for changing a composition of an image of the image forming device according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

Hereinafter, exemplary embodiments of the present invention will be described in detail with reference to the accompanying drawing figures.

The matters defined in the description such as a detailed construction and elements are nothing but the ones provided to assist in a comprehensive understanding of the invention. Thus, it is apparent that the present invention can be carried out without those defined matters. Also, descriptions of well-known functions or constructions are omitted for clarity and conciseness.

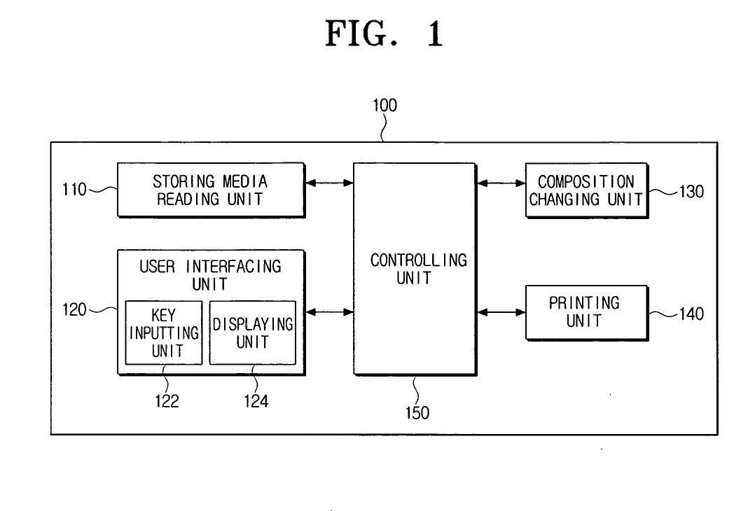

FIG. 1 is a block diagram of an image forming device for changing a composition of an image according to an exemplary embodiment of the present invention.

Referring to FIG. 1, according to an exemplary embodiment of the present invention, the image forming device 100 for changing a composition of an image includes a storing medium reading unit 110, a user interfacing unit 120, a composition changing unit 130, a printing unit 140 and a controlling unit 150.

The storing media reading unit 110 reads an image to be printed from an external storing media (not shown), for example a Universal Serial Bus (USB) memory, a digital camera, a digital camcorder and the like.

According to an exemplary embodiment of the present invention, the image can be input from an external storage media by the storing media reading unit 110 in a printing system where the image forming device 100 directly outputs the image stored in the external storage media without a host device. However, the image may be input from the host device.

The user interfacing unit 120 supports an interface between the image forming device 100 and a user. The user interfacing unit 120 includes a key inputting unit 122 or other type of user input device such as a directional input dial for receiving a requesting signal by the user's operation and a displaying unit 124 for displaying information. According to an exemplary embodiment of the present invention, the key inputting unit 122 and the displaying unit 124 are provided. In another exemplary embodiment, the displaying unit 124 may be provided having a touch screen or other form so as to also function as an input unit.

The key inputting unit 122 preferably includes a plurality of function keys formed on a front panel of the general image forming device 100. The user may input, through the key inputting unit 122, information for determining a reference area to be applied for changing a composition of an image displayed on the displaying unit 124. The user may also use the inputting unit 122 for selecting and inputting an output direction to be applied when outputting the image. The output direction selected by the user may be one of a landscape or a portrait direction, or the landscape and the portrait may be applied together.

The displaying unit 124 is formed on the front panel of the image forming device 100, like the key inputting unit 122. The displaying unit may displays information transmitted to and output by the image forming device 100. The displaying unit 124 displays the image read through the storing media reading unit 110 to help the user recognize the image. The displaying unit 124 also displays a plurality of images having a composition changed by the composition changing unit 130. The controlling unit 150 controls various pieces of information including the image to be displayed on the displaying unit 124.

The composition changing unit 130 generates a new image by changing the composition of the input image according to at least one composition based on the reference area to be applied in changing the composition of the image.

As mentioned above, the reference area to be applied in changing the composition of the image may be input into the composition changing unit 130 through the key inputting unit 122 and the displaying unit 124, or an external device (not shown) connected to the image forming device 100 in a connection method.

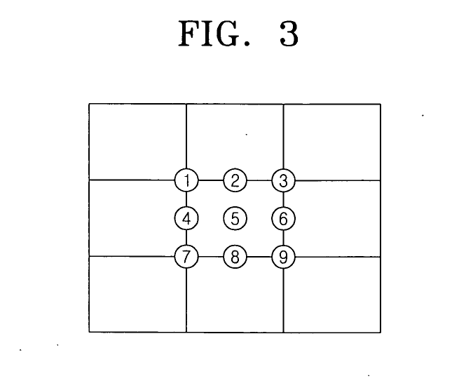

An exemplary composition is shown in FIG. 3 having positions I through 9. The determined composition may be selected from two or more preset compositions, to provide images having changed composition in various forms. For example, another determined composition may consist of only the positions 1 through 6. Other compositions can be set by the user. Accordingly, a plurality of new images may be generated by the composition changing unit 130 for a plurality of compositions, respectively.

The composition changing unit 130 sets a center point of the reference area of the image, and moves the center point to at least one point which is away from the original center point in one or a plurality of directions a selected distance (e.g., number of pixels), to generate a new image or images. The composition changing unit 130 applies an output direction, input through the key inputting unit 122 by the user, to generate the new image.

The composition to be applied for changing the composition of the image by the composition changing unit 130 may be in a golden ratio of a photographic technique in consideration of a stable location of a subject (figure and still life) in the image.

A method for changing the composition by the composition changing unit 130 will be described later in detail with reference to FIG. 3.

The printing unit 140 performs a printing function which is a basic function of the image forming device 100. The printing unit 140 outputs an image selected by the user from the plurality of new images generated by the composition changing unit 130 under control of the controlling unit 150.

The controlling unit 150 controls overall functions of the image forming device 100. The controlling unit 150 controls signal input and output between the storing media reading unit 110 and the user interfacing unit 120, that is, between the key inputting unit 122, the displaying unit 124, the composition changing unit 130 and the printing unit 140.

The controlling unit 150 controls the displaying unit 124 to display the new images. A plurality of new images are generated by the composition changing unit 130 and respectively displayed by displaying unit 124 if the compositions to be applied for changing the composition by the composition changing unit 130 is two or more.

The controlling unit 150 controls the printing unit 140 to print a selected image when the user selects one of the plurality of new images displayed on the displaying unit 124 through the key inputting unit 122.

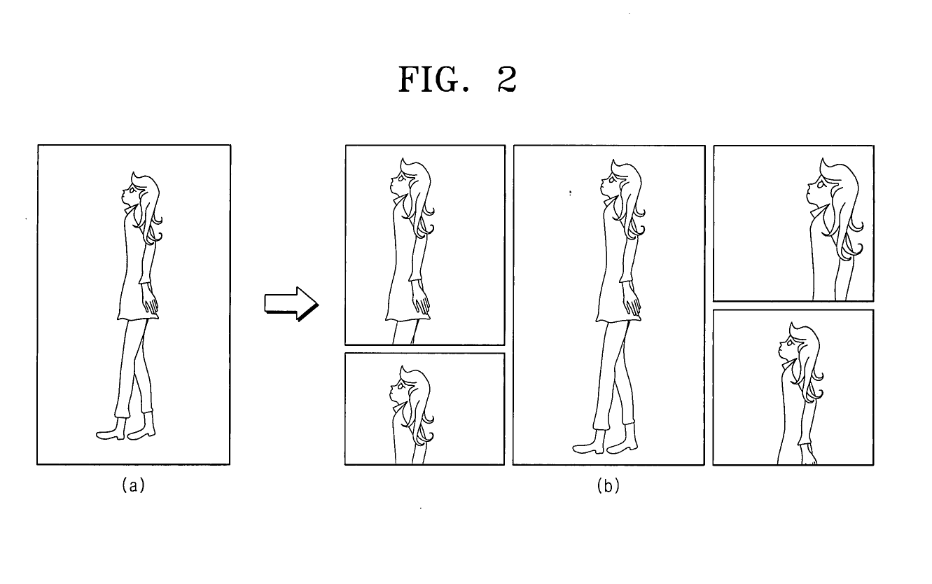

FIG. 2 is an example of changing the composition by use of the image forming device according to an exemplary embodiment of the present invention.

FIG. 2 shows an example of changing the composition of an image according to various compositions by the composition changing unit 130. In FIG. 2, (a) is an original image read from the storing media reading unit 110, and (b) is a new image in various forms obtained by changing the composition of the original image of (a) according to various compositions determined by the composition changing unit 130.

As illustrated in (b), it is possible to change a location of a subject in an image, by changing the composition by the composition changing unit 130, and to change the size of an image output by the printing unit 140 according to a printing area set by the user.

FIG. 3 is provided to explain an exemplary method for changing the composition of the composition changing unit of FIG. 1.

Referring to FIG. 3, the method of changing the composition is performed by moving a center point 5 based on the center point of the reference area input by the user in changing the composition by the composition changing unit 130.

If the external most edge is the reference area set by the user, the center point 5 is set in the mid-center of the reference area. Composition-changed points (1 through 4, and 6 through 9) may be set at positions (e.g., a specified number of pixels) which are away from the center point 5 in an interval in a plurality of directions.

The composition of the images may be changed according to the points (1 through 4, and 6 through 9) by the composition changing point 130. That is, the composition changing unit 130 moves the center point 5 of the reference area in the image set by the user to the points (1 through 4, and 6 through 9), to change the composition of the image.

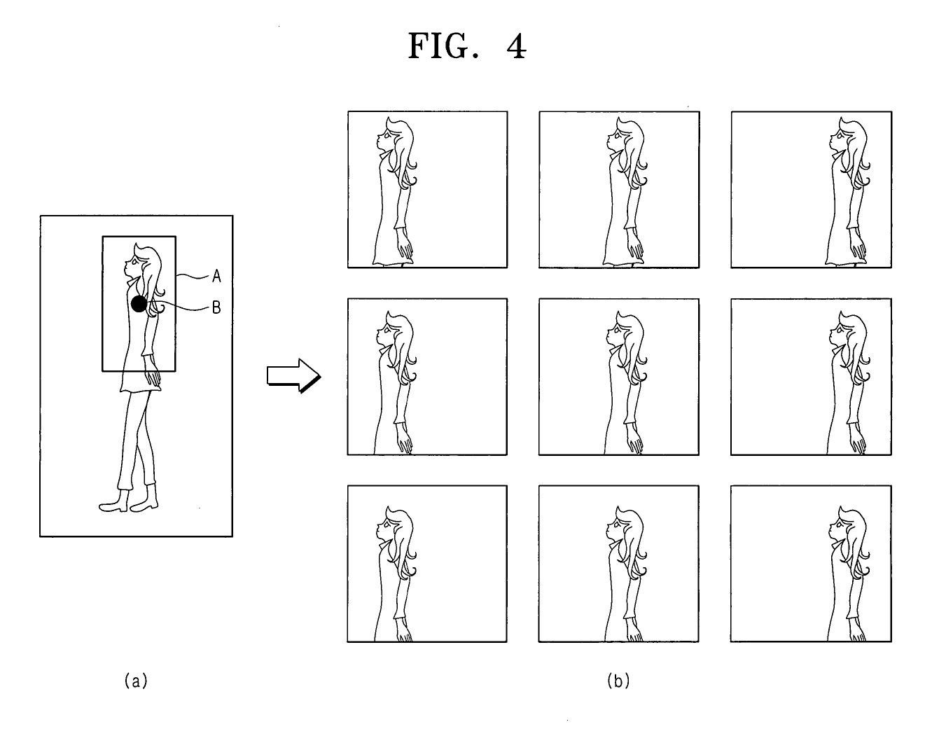

FIG. 4 exemplifies a result of changing the composition of an image by the composition changing unit 130 of FIG. 1.

In FIG. 4, (a) is the original image input through the storing media reading unit 110. When the original image is displayed on the displaying unit 124, the user sets a reference area A illustrated in a square form in the image through the key inputting unit 122.

When the reference area A is set by the user, the composition changing unit 130 sets a center point B of the set reference area A. The composition changing unit 130 changes the composition of the center point B in various forms according to a composition, for example according to the composition illustrated in FIG. 3.

If the center point B of the reference area A is moved according to each point (1 through 9), 9 new images are generated by the composition changing unit 130, by changing the composition, as illustrated in (b).

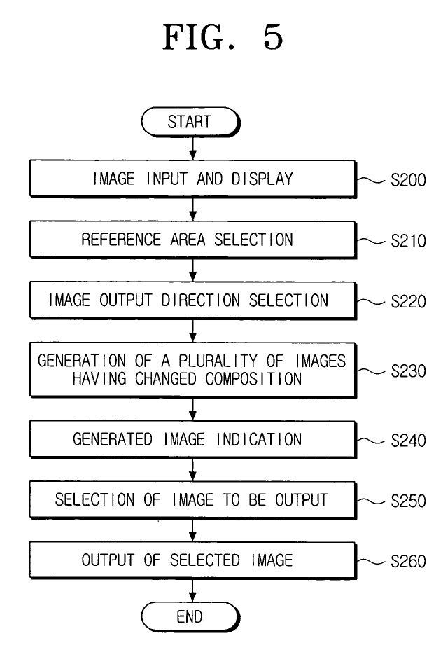

FIG. 5 is a flowchart explaining a method for changing the composition of an image using the image forming device according to an exemplary embodiment of the present invention.

When an image read from the external storing media by the storing media reading unit 110 is input, the controlling unit 150 controls the displaying unit 124 to display the input image. The displaying unit 124 displays the image under control of the controlling unit 150, to allow the user to recognize the image (S200).

The user confirms the image displayed on the displaying unit 124, and operates the key inputting unit 122, to set the reference area A to be applied for changing the composition of the image. The reference area A set by the user is input into the controlling unit 150 from the key inputting unit 122 (S210).

The user sets the reference area A, which is applied for changing the composition of the image, and operates the key inputting unit 122. The user selects an output direction to be applied for outputting the image, that is, a landscape or a portrait (S220).

When the user is finished with setting the reference area A and the output direction, a new image is generated by changing the composition of the image according to various compositions of the composition changing unit 130. The method of changing the composition by the composition changing unit 130 may be performed the same as illustrated in FIGS. 3 through 4 (S230).

If the new image is generated, by changing the composition of the input image by the composition changing unit 130, the controlling unit 150 controls the generated image to be displayed on the displaying unit 124. Accordingly, a plurality of images such as (b) in FIG. 4 is displayed on the displaying unit 124 (S240).

The user operates the key inputting unit 122 and selects one image, having changed composition in his or her desired form, from a plurality of images displayed on the displaying unit 124. The image selection by the user is input into the controlling unit 150 through the key inputting unit 122 (S250).

The controlling unit 150 controls the printing unit 140 to print the image selected by the user. The printing unit 140 prints the image selected by the user under control of the controlling unit 150 (S260).

In this process, without having to directly set the composition, the user checks the plurality of images having variously changed compositions through the displaying unit 124, and easily selects and outputs the plurality of images having the changed composition in his or her desired form.

As mentioned above, an image forming device for changing a composition of an image and changing method thereof provides a variety of images having a changed composition according to various compositions, not requiring the user to directly change the composition of images, and the user can selectively output the image having changed compositions in his or her desired form, easily.

While the invention has been shown and described with reference to certain embodiments thereof, it will be understood by those skilled in the art that various changes in form and details may be made therein without departing from the spirit and scope of the invention as defined by the appended claims and the full scope of equivalents thereof.

What is claimed is:

1. An image forming device for changing a composition of an image, comprising:
a user interface unit for displaying an input image;
a composition changing unit for generating a new image by changing a composition of the input image according to a determined composition; and
a printing unit for outputting the generated image.

2. The image forming device of claim 1, wherein the user interface unit receives a reference area to be applied for changing the composition of the displayed image from the user, and the composition changing unit changes the composition of the image according to the determined composition based on the received reference area.

3. The image forming device of claim 1, further comprising a controlling unit for controlling a plurality of images generated by the composition changing unit for a plurality of compositions, respectively, to be displayed on the user interface unit when the determined composition is two or more.

4. The image forming device of claim 3, wherein the user interface unit receives an image to be output from the plurality of images and the printing unit outputs the image received through the user interfacing unit.

5. The image forming device of claim 1, wherein the composition changing unit changes the composition by moving a center point of the received reference area a selected distance.

6. The image forming device of claim 5, wherein the selected distance is a certain number of pixels.

7. The image forming device of claim 1, wherein the user interface unit receives an output direction to be applied for outputting the image from the user, and the composition changing unit generates the new image in the received output direction.

8. The image forming device of claim 1, wherein the determined composition is at a golden ratio in consideration of a selected location of a subject in the image.

9. A method for changing a composition of an image, comprising:
receiving and displaying an input image;
generating a new image by changing a composition of the image according to a determined composition; and
outputting the generated image.

10. The method for changing a composition of an image of claim 9, further comprising receiving input regarding a reference area to be applied for changing the composition of the displayed image,
wherein the new image is obtained by changing the composition of the image according to at least one composition determined based on the received reference area, in the operation of generating the new image.

11. The method for changing a composition of an image of claim 10, wherein receiving input regarding the reference area comprises receiving input regarding the reference area through at least one of an operation panel and an externally connected device,.

12. The method for changing a composition of an image of claim 9, further comprising displaying a plurality of images generated for a plurality of determined compositions, respectively when the determined composition is two or more.

13. The method for changing a composition of an image of claim 12, further comprising receiving input regarding an image to be output from the plurality images from the user,
wherein the received image is output in the operation of outputting the image.

14. The method for changing a composition of an image of claim 9, wherein the composition is changed by moving a center point of the received reference area a selected distance in the operation of generating the new image.

15. The method for changing a composition of an image of claim 9, further comprising receiving an output direction to be applied for outputting the image,
wherein the image is generated in the received output direction in the operation of generating the new image.

16. The method for changing a composition of an image of claim 9, wherein at least one determined composition is at a golden ratio in consideration of a stable location of a subject in the image.

17. A method for changing a composition of an image, comprising:
receiving and displaying an input image;
receiving input regarding a reference area to be applied for changing the composition of the displayed image;
changing the composition of the input image according to at least one composition determined based on the received reference area; and
displaying at least one new image generated for the at least one determined compositions, respectively.

18. The method for changing a composition of an image of claim 17, wherein receiving input regarding the reference area comprises receiving input regarding the reference area through at least one of an operation panel and an externally connected device.

19. The method for changing a composition of an image of claim 17, further comprising receiving input regarding an image to be output from the at least one new image from the user.

20. The method for changing a composition of an image of claim 18, wherein the composition is changed by moving a center point of the received reference area a selected distance in the operation of generating the new image.
